(19) United States
(12) Patent Application Publication
(10) Pub. No.: US 2015/0108744 A1
(43) Pub. Date: Apr. 23, 2015

(54) INTEGRATED SIDE IMPACT AND REAR OCCUPANT FRONT IMPACT PROTECTION BOLSTERS

(71) Applicant: Ford Global Technologies,LLC, Dearborn, MI (US)

(72) Inventors: Johnathan Andrew Line, Northville, MI (US); Sean West, Monroe, MI (US)

(73) Assignee: Ford Global Technologies,LLC, Dearborn, MI (US)

(21) Appl. No.: 14/056,005

(22) Filed: Oct. 17, 2013

(51) Int. Cl. B60R 21/26; B60R 21/207; B60R 21/231; B60N 2/42; B60R 21/215

(52) U.S. Cl. CPC B60R 21/26; B60N 2/4221; B60N 2/4235; B60R 21/215; B60R 21/23138; B60R 21/207; B60R 2021/23107; B60R 2021/23146; B60R 2021/23153; B60R 2021/23169; B60R 2021/26094
USPC 280/730.2; 280/734

(57) ABSTRACT

A vehicle seating assembly includes a seatback having a forward cushion surface and a back panel. An airbag deployment system is operably coupled to a crash pulse module. A side airbag is disposed between the forward cushion surface and the back panel proximate a side portion of the seatback. A bolster airbag is disposed between the forward cushion surface and the back panel proximate a lower portion of the back panel. A single inflator is in communication with both the side airbag and the bolster airbag. A valve assembly is operably coupled with the single inflator and is in communication with the crash pulse module. The valve assembly is configured to activate at least one of the side airbag and the bolster airbag during a collision event.

### FIELD OF THE INVENTION

The present invention generally relates to a vehicle seating assembly, and more particularly to a vehicle seating assembly having side impact and rear occupant front impact protection bolsters for providing protection to vehicle passengers.

### BACKGROUND OF THE INVENTION

Vehicles that include improved airbag systems increase safety and value to the consumer.

### SUMMARY OF THE INVENTION

According to one aspect of the present invention, a vehicle seating assembly includes a seatback having a forward cushion surface and a back panel. An airbag deployment system is operably coupled to a crash pulse module. A side airbag is disposed between the forward cushion surface and the back panel proximate a side portion of the seatback. A bolster airbag is disposed between the forward cushion surface and the back panel proximate a lower portion of the back panel. A single inflator is in communication with both the side airbag and the bolster airbag. A valve assembly is operably coupled with the single inflator and is in communication with the crash pulse module. The valve assembly is configured to activate at least one of the side airbag and the bolster airbag during a collision event.

According to another aspect of the present invention, a vehicle seating assembly including a seatback. An airbag deployment system is operably coupled to a crash pulse module. A side airbag is proximate a side portion of the seatback. A bolster airbag is proximate a rear of the seatback. A valve assembly is operably coupled with a single inflator and is in communication with the crash pulse module. The valve assembly is configured to activate at least one of the side airbag and the bolster airbag.

According to yet another aspect of the present invention, a vehicle seating assembly includes a seatback having an airbag deployment system that includes a single inflator operably coupled with both a side airbag and a bolster airbag. A valve assembly is operably coupled with the single inflator and is in communication with a crash pulse module. The valve assembly is configured to activate one or both of the side airbag and the bolster airbag during a collision event.

These and other aspects, objects, and features of the present invention will be understood and appreciated by those skilled in the art upon studying the following specification, claims, and appended drawings.

### BRIEF DESCRIPTION OF THE DRAWINGS

In the drawings:

FIG. 1 is a front perspective view of a vehicle having a vehicle seat according to one embodiment of the present invention;

FIG. 2 is a top perspective view of a vehicle interior having a vehicle seating assembly;

FIG. 3 is a front perspective view of the vehicle seating assembly with a side airbag and a bolster airbag in a deployed position;

FIG. 4 is a rear perspective view of the vehicle seat having an airbag deployment system;

FIG. 5 is a top plan cross-sectional view of the vehicle seat;

FIG. 6 is a top plan cross-sectional view of a vehicle seating assembly with the side airbag in the deployed position;

FIG. 7 is a cross-sectional view of the vehicle seating assembly with the bolster airbag in the deployed position;

FIG. 8 is a cross-sectional view of the vehicle seating assembly with both the side airbag and the bolster airbag in the deployed position;

FIG. 9A is a schematic view of one embodiment of a bolster airbag;

FIG. 9B is a schematic view of one embodiment of a bolster airbag;

FIG. 10 is a side perspective view of a vehicle seating assembly having a deployed side airbag;

FIG. 11 is a side perspective view of a vehicle seating assembly having a deployed bolster airbag; and

FIG. 12 is a side perspective view of a vehicle seating assembly having a deployed bolster airbag and side airbag.

### DETAILED DESCRIPTION OF EMBODIMENTS

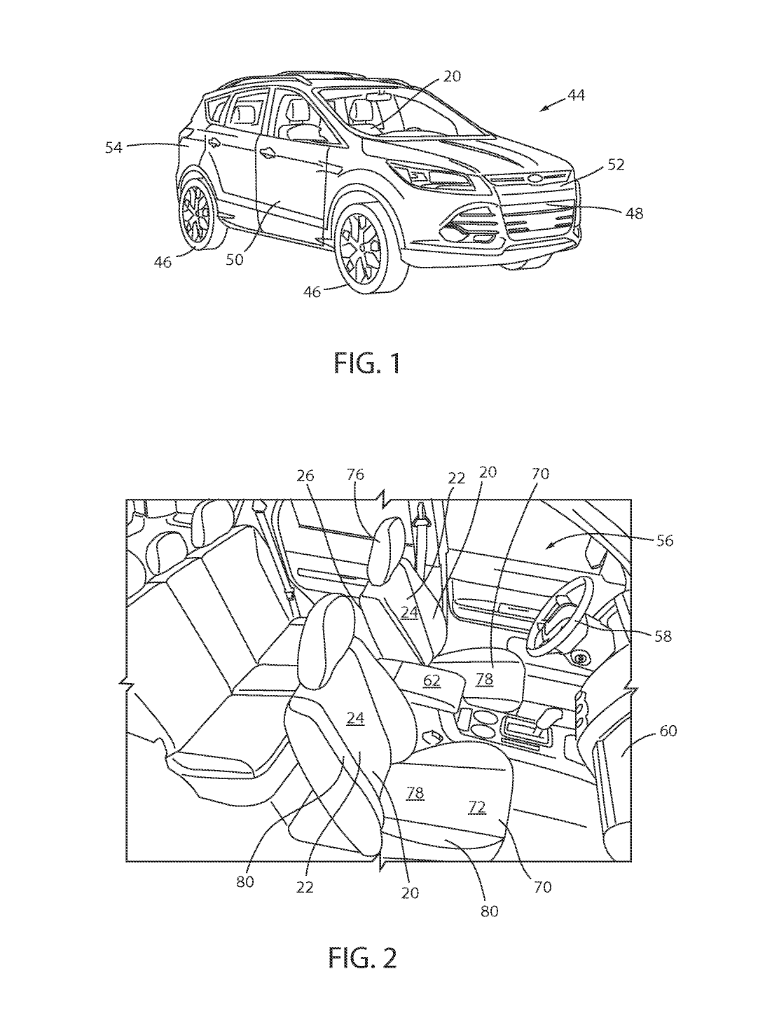

For purposes of description herein, the terms “upper,” “lower,” “right,” “left,” “rear,” “front,” “vertical,” “horizontal,” and derivatives thereof shall relate to the invention as oriented in FIG. 1. However, it is to be understood that the invention may assume various alternative orientations, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

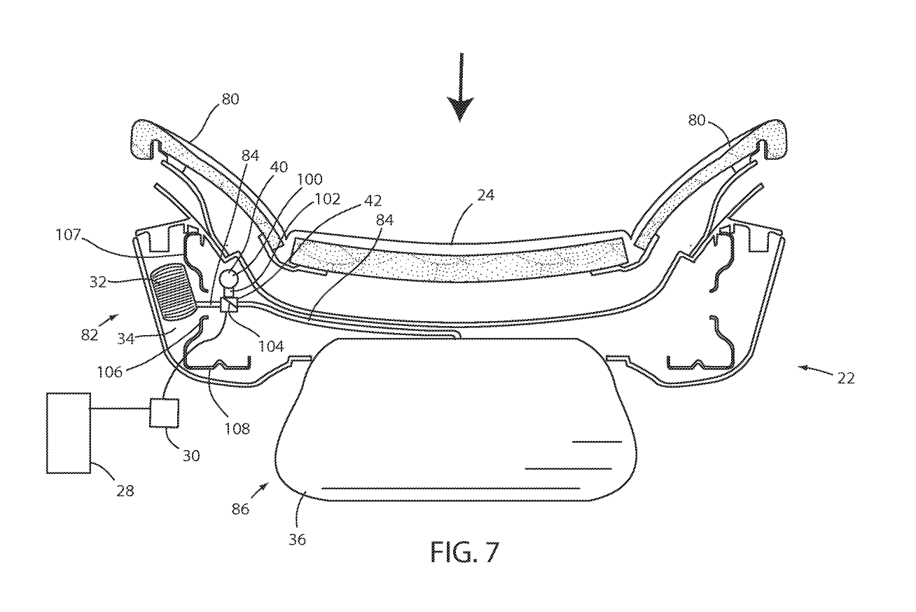

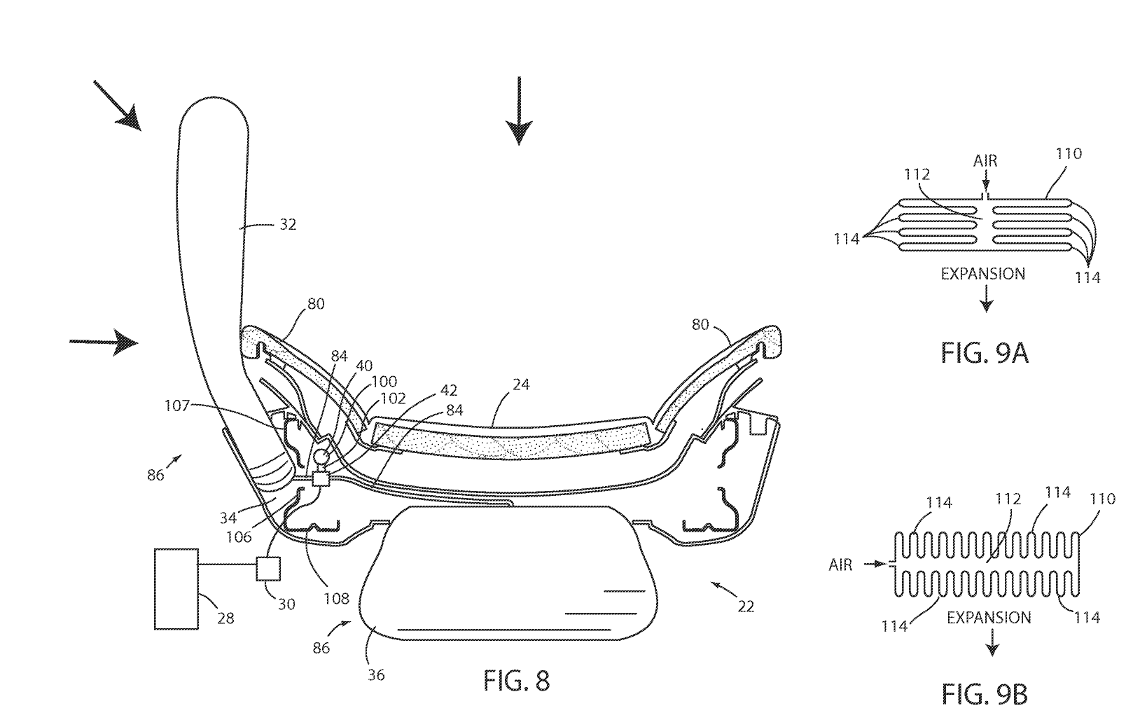

Referring to FIGS. 1-12, reference numeral 20 generally designates a vehicle seating assembly including a seatback 22 having a forward cushion surface 24 and a back panel 26. The vehicle seating assembly 20 further includes an airbag deployment system 28, which is operably coupled to a crash pulse module 30. The airbag deployment system 28 includes a side airbag 32 disposed between the forward cushion surface 24 and the back panel 26 proximate a side portion 34 of the seatback 22, and a bolster airbag 36 disposed between the forward cushion surface 24 and the back panel 26 proximate a lower portion 38 of the back panel 26. The airbag deployment system 28 also includes a single inflator 40 in communication with both the side airbag 32 and the bolster airbag 36. Moreover, a valve assembly 42 is operably coupled with the single inflator 40. The valve assembly 42 is in communication with the crash pulse module 30 and is configured to activate at least one of the side airbag 32 and the bolster airbag 36 during a collision event.

Referring again to FIG. 1, a vehicle 44 includes the vehicle seating assembly 20 and also includes other features, such as multiple wheels 46, a bumper 48, multiple doors 50, a front end 52, and a rear end 54. The vehicle 44 may be of any type, including a compact vehicle, a mid-size vehicle, a sport utility vehicle, a mini or full size van, or any type of truck. As illustrated in the embodiment of FIG. 2, an interior 56 of the vehicle 44 includes multiple vehicle seat assemblies 20. The vehicle seating assembly 20 of the present invention may be any type of vehicle seat including a driver's seat, a front passenger seat, or a rear passenger seat. Additionally, the interior 56 of the vehicle 44 includes other features, such as a steering wheel 58, a dashboard 60, and a center console 62 for storage purposes.

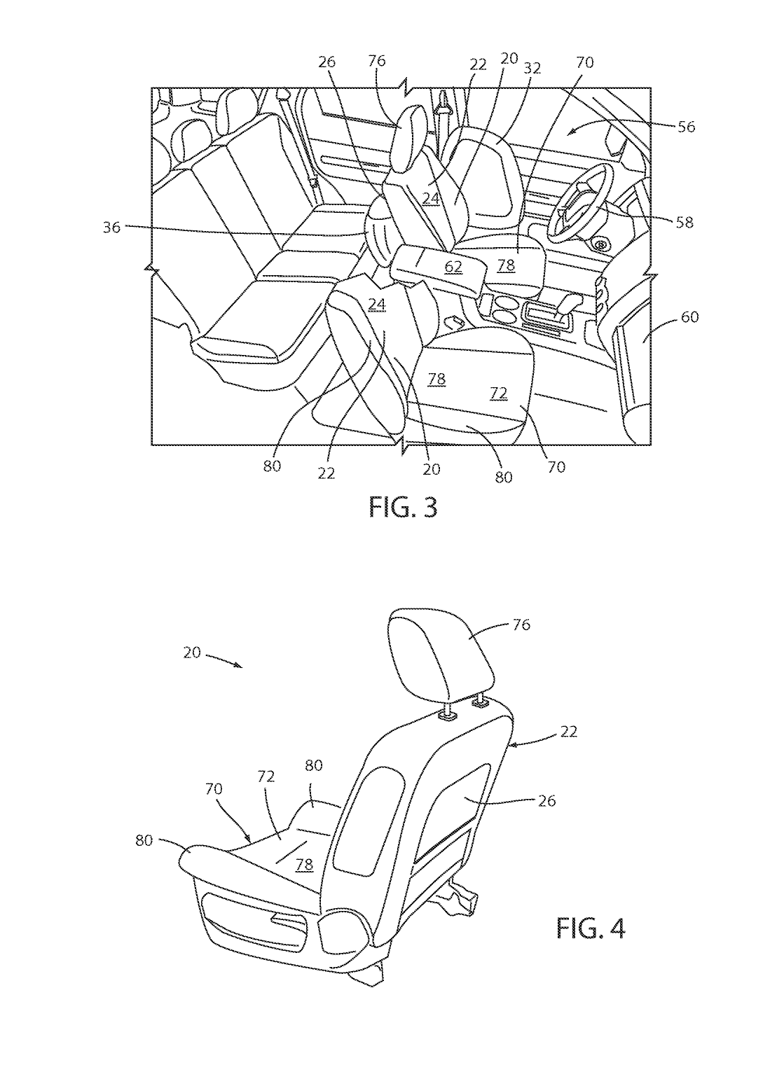

Referring now to the embodiments shown in FIGS. 3 and 4, the vehicle seating assembly 20 may also include the seatback 22 having the forward cushion surface 24 and the back panel 26 and a seat base 70 having a top surface 72 and a bottom surface 74. The seatback 22 includes both the side airbag 32 and the bolster airbag 36. The vehicle seating assembly 20 may also include a headrest 76 and a coverstock 78. The coverstock 78 is disposed completely over the seatback 22 and the seat base 70. The coverstock 78 is configured to provide a uniform look and feel to the vehicle seating assembly 20. The coverstock 78 also forms a passenger engagement surface on the top surface 72 of both the seatback 22 and the seat base 70 of the vehicle seating assembly 20. The vehicle seating assembly 20 may also include side bolsters 80, which are disposed on both the seatback 22 and the seat base 70 in order to provide the vehicle passenger with a more comfortable vehicle seat. Additionally, the vehicle seating assembly 20 may include the airbag deployment system 28 configured to deploy one or both of the side airbag 32 and the bolster airbag 36. The crash pulse module 30 may be operably coupled to the airbag deployment system 28. The crash pulse module 30 is configured to determine whether a collision event has occurred and further determine whether the collision event is a frontal collision event, a side collision event, or other collision event.

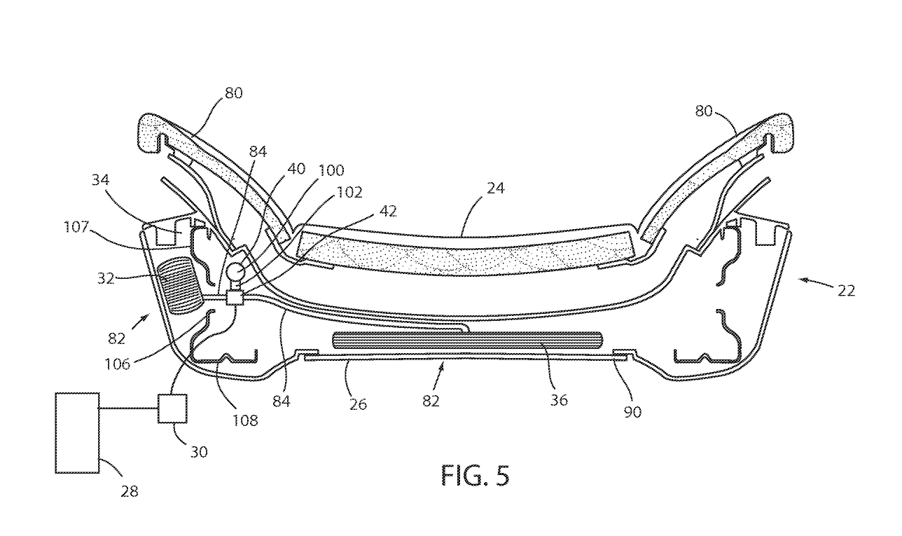

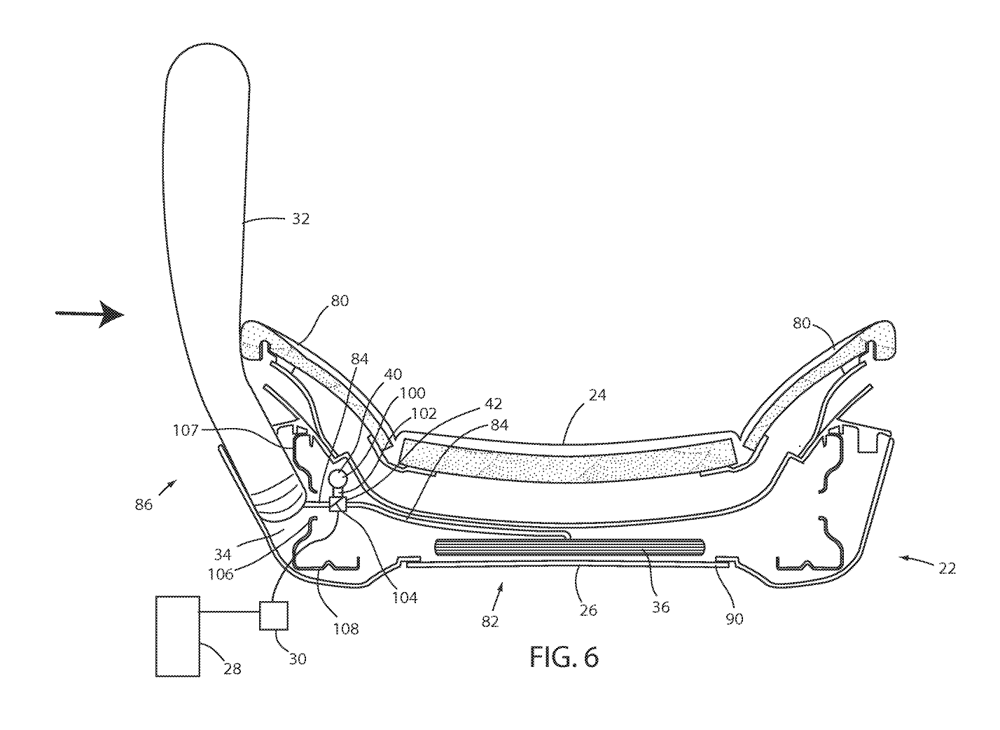

Referring now to the embodiment shown in FIG. 5, the side airbag 32 is generally disposed between the forward cushion surface 24 and the back panel 26 of the seatback 22. The side airbag 32 is configured to provide protection between the vehicle door 50 and the vehicle passenger during a side collision event. The side airbag 32 begins in a deflated position 82 and is generally folded and disposed in the seatback 22, hidden from view. Upon the crash pulse module 30 detecting the side collision event, the airbag deployment system 28 signals the inflator 40 to produce air, which travels through an air line 84, and moves the side airbag 32 to an inflated position 86, as shown in FIG. 6. The side airbag 32 is generally made of a polypropylene material and may be formed using injection molding or blow molding to align bellows 114 (see FIGS. 9A, 9B) so that the side airbag 32 expands properly. The polypropylene material is thickest on the portion of the side airbag 32 operably coupled with the air line 84 and thinnest on the portion of the side airbag 32 configured to come into contact with the vehicle passenger. This configuration allows the side airbag 32 to deploy in a balloon-like way and in a uniform direction. However, it is also contemplated that the side airbag 32 may be made of another plastic polymer, a cloth fabric, or any other material as known by one of ordinary skill in the art. It is also contemplated that the side airbag 32 would be otherwise formed in the seatback 22 or formed outside of the seatback 22 and later placed into the seatback 22 as known by one of ordinary skill in the art.

Referring again to the embodiment shown in FIG. 5, the seatback 22 of the vehicle seating assembly 20 also includes the bolster airbag 36. Similar to the side airbag 32, the bolster airbag 36 is generally made of a polypropylene material and is usually injection molded into the seatback 22. Moreover, similar to the side airbag 32 as described above, the bolster airbag 36 is configured to be moved from the deflated position 82 to the inflated position 86. Specifically, when a signal from the crash pulse module 30 is detected by the airbag deployment system 28 signaling the frontal collision event, gas produced by the inflator 40 travels through the air line 84 and to the bolster airbag 36. A breakaway portion 90 of the back panel 26 is disposed directly behind the bolster airbag 36 such that when the bolster airbag 36 is in the inflated position 86, the breakaway portion 90 of the back panel 26 breaks away from the seatback 22. The breakaway portion 90 may be a decorative cover or a detachable section, generally made of a hard plastic material. It is contemplated that the breakaway portion 90 of the back panel 26 moves rearward out of the seatback 22 approximately 150 to 250 millimeters, and more specifically, approximately 180 millimeters, in order to provide protection to the knees of a rear vehicle seat passenger during the frontal collision event. The breakaway portion 90 of the back panel 26 may be made of a plastic polymer material, or may be made of any other material used for the back panel 26 of the seatback 22. The breakaway portion 90 of the back panel 26 is configured to provide a uniform look and feel to the vehicle seating assembly 20 such that the color and material of the breakaway portion 90 of the back panel 26 is generally the same material and color of the rest of the back panel 26. However, it is also contemplated that the breakaway portion 90 of the back panel 26 may include a cushioned portion that would provide even more comfort to the knees of a rear seat passenger during the frontal collision event. It is also contemplated that the breakaway portion 90 of the back panel 26 may be a breakaway cover, such that when the bolster airbag 36 is inflated, the breakaway portion 90 breaks away and allows the rear passenger to come in direct contact with the bolster airbag 36 during the frontal collision event.

Referring now to the embodiments shown in FIGS. 5-8, the seatback 22 also includes the single inflator 40, which is configured to move one or both of the side airbag 32 and the bolster airbag 36 to the inflated position 86. The inflator 40 includes an initiator 100 which, when activated, ignites a propellant 102 that moves the side airbag 32 or the front impact protection bolster to the inflated position 86. The inflator 40 includes the valve assembly 42, including a valve plate 104, which is in communication with both the side airbag 32 and the bolster airbag 36. The valve plate 104 moves in order to allow the inflator 40 to inflate the side airbag 32 alone, the bolster airbag 36 alone, or both the side airbag 32 and the bolster airbag 36, based on the signal received from the crash pulse module 30. In order to deploy the side airbag 32 alone, the valve plate 104 forms an airtight seal with the air line 84 operably coupled to the bolster airbag 36, thereby preventing any gas produced by the inflator 40 to enter the air line 84 coupled to the bolster airbag 36, which prevents the bolster airbag 36 from being moved to the inflated position 86. The inflator 40 along with the valve assembly 42 may be operably coupled with a vehicle seat structural support 106. The vehicle seat structural support 106 includes a sidewall 107 and a rear wall 108 and the valve assembly 42 is disposed proximate the sidewall 107 and the rear wall 108 of the vehicle structural support 106.

Referring again to the embodiments shown in FIGS. 5-8, as described above, the inflator 40 is configured to move one or both of the side airbag 32 and the bolster airbag 36 to the inflated position 86. In operation, the inflator 40 produces enough gas in order to provide the necessary pressure to inflate both the side airbag 32 and the bolster airbag 36. However, if the crash pulse module 30 only detects the side collision event, the portion of the gas that would inflate the bolster airbag 36, which is not needed in the side collision event, will be let out into the interior 56 of the vehicle 44, harmlessly. The opposite is true if the frontal collision event is detected by the crash pulse module 30 and not the side collision event (i.e., the gas that would be directed toward the side airbag 32 would be allowed to escape into the vehicle interior 56). However, it is also contemplated that the inflator 40 only produces enough gas to inflate only one of the side airbag 32 or the bolster airbag 36 as determined by the airbag deployment system 28 based on signals from the crash pulse module 30.

Referring again to the embodiment shown in FIGS. 6-8, the airbag deployment system 28 determines whether the side impact airbag will be moved to the inflated position 86, the protection bolster will be moved to the inflated position 86, or if both the side impact airbag and the protection bolster will be moved to the inflated position 86 by receiving signals from the crash pulse module 30. Specifically, the vehicle 44 is equipped with pressure sensors disposed on the doors 50 of the vehicle 44 and also on the front end 52 and the rear end 54 of the vehicle 44 which send signals to the crash pulse module 30. The pressure sensors determine pressure on a particular portion of the vehicle 44 and report the pressure to the crash pulse module 30. If the crash pulse module 30 determines that the pressure is over a threshold, then the airbag deployment system 28 will deploy the corresponding side airbag 32 or the bolster airbag 36. The pressure sensors may also be equipped with accelerometers, which can prevent either the side airbag 32 or the bolster airbag 36 from deploying unless the vehicle 44 is traveling at least a certain speed. This prevents unnecessary inflation of both the side airbag 32 and the bolster airbag 36.

Referring now to the embodiment shown in FIGS. 9A and 9B, the illustrated embodiments of the bolster airbag 36, which are formed via blow molding techniques, may include at least one air bladder 110. The air bladder 110 includes a main cavity 112 and the plurality of laterally extending bellows 114. In one embodiment of the air bladder 110, as illustrated in FIG. 9A, the main cavity 112 is disposed perpendicular to the back panel 26 of the seatback 22 and the bellows 114 are disposed parallel to the back panel 26 of the seatback 22. When the bolster airbag 36 is moved to the inflated position 86, gas moves through the main cavity 112 and the air bladder 110 extends in the direction of the gas flow towards the knees of the vehicle passenger. In another embodiment, as illustrated in FIG. 9B, the main cavity 112 is disposed parallel to the back panel 26 of the seatback 22 and the bellows 114 extend perpendicular to the back panel 26 of the seatback 22. When the bolster airbag 36 is moved to the inflated position 86, gas again moves through the main cavity 112. However, the air bladder 110 expands in the direction of the extending bellows 114 and perpendicular with the back panel 26 of the seatback 22 and extends toward the knees of the vehicle passenger.

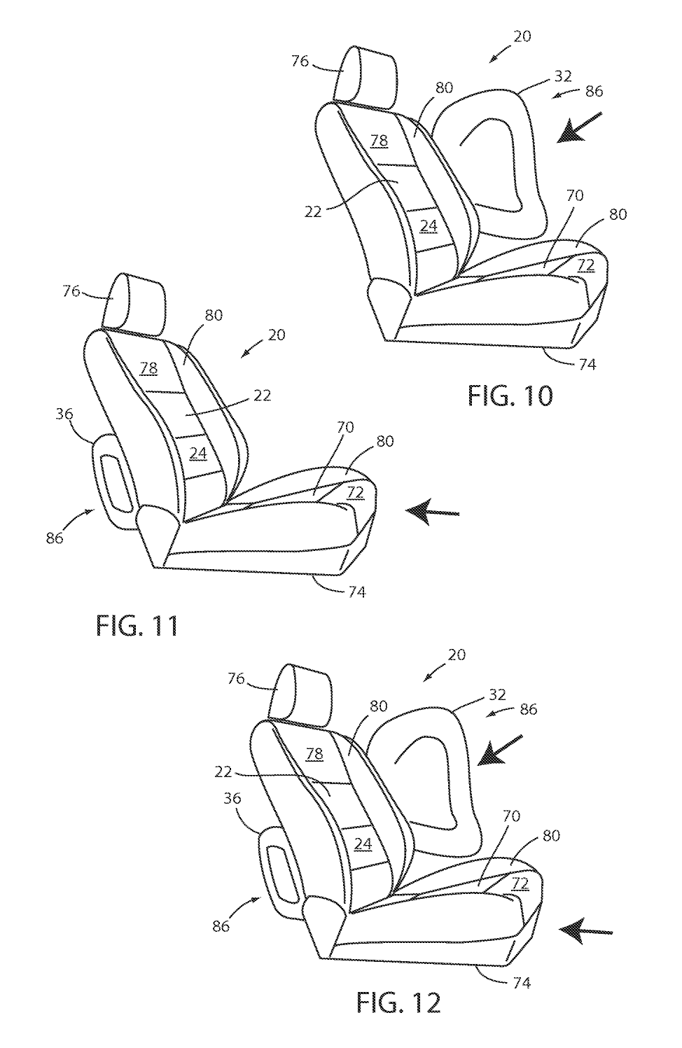

Referring now to the embodiment shown in FIGS. 10-12, in operation, the vehicle 44 is traveling at a given speed in a generally forward direction. Upon a frontal collision event, the airbag deployment system 28 activates the inflator 40 which can move the bolster airbag 36 to the inflated position 86 in order to provide protection for a vehicle passenger seated behind the vehicle seating assembly 20. In the event of a side collision event, the airbag deployment system 28 again activates the inflator 40, which then moves the side airbag 32 to the inflated position 86, which provides protection for the vehicle passenger seated on the vehicle seating assembly 20. In the case of a collision event that is a combined side collision event and frontal collision event, the airbag deployment system 28 activates the inflator 40, which then moves both the side airbag 32 and the bolster airbag 36 to the inflated position 86, which provides protection to both the vehicle passenger seated on the vehicle seating assembly 20 and the vehicle passenger seated behind the vehicle seating assembly 20.

Yet another aspect of the present invention is to provide increased protection to a vehicle passenger seated in the vehicle seating assembly and also to provide improved protection to a vehicle passenger seated behind the vehicle seating assembly. Prior vehicle seating assemblies do not include a protection bolster in order to provide protection to a rear vehicle passenger. In addition, the present invention uses a single inflator to inflate both a side airbag and a bolster airbag, which decreases space and cost used for an airbag deployment system. The present invention also includes a crash pulse module that senses pressure during a side collision event or a frontal collision event, and then signals the inflator to move either one or both of the side airbag and the bolster airbag to the inflated position, in order to provide protection to both the vehicle passenger seated on the vehicle seating assembly and the vehicle passenger seated behind the vehicle seating assembly.

It is to be understood that variations and modifications can be made on the aforementioned structure without departing from the concepts of the present invention, and further it is to be understood that such concepts are intended to be covered by the following claims unless these claims by their language expressly state otherwise.

It is to be understood that variations and modifications can be made on the aforementioned structure without departing from the concepts of the present invention, and further it is to be understood that such concepts are intended to be covered by the following claims unless these claims by their language expressly state otherwise.

It will be understood by one having ordinary skill in the art that construction of the described invention and other components is not limited to any specific material. Other exemplary embodiments of the invention disclosed herein may be formed from a wide variety of materials, unless described otherwise herein.

For purposes of this disclosure, the term “coupled” (in all of its forms, couple, coupling, coupled, etc.) generally means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components. Such joining may be permanent in nature or may be removable or releasable in nature unless otherwise stated.

It is also important to note that the construction and arrangement of the elements of the invention as shown in the exemplary embodiments is illustrative only. Although only a few embodiments of the present innovations have been described in detail in this disclosure, those skilled in the art who receive this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed, the operation of the interfaces may be reversed or otherwise varied, the length or width of the structures and/or members or connector or other elements of the system may be varied, the nature or number of adjustment positions provided between the elements may be varied. It should be noted that the elements and/or assemblies of the system may be constructed from any of a wide variety of materials that provide sufficient strength or durability, in any of a wide variety of colors, textures, and combinations. Accordingly, all such modifications are intended to be included within the scope of the present innovations. Other substitutions, modifications, changes, and omissions may be made in the design, operating conditions, and arrangement of the desired and other exemplary embodiments without departing from the spirit of the present innovations.

It will be understood that any described processes or steps within described processes may be combined with other disclosed processes or steps to form structures within the scope of the present invention. The exemplary structures and processes disclosed herein are for illustrative purposes and are not to be construed as limiting.

It is also to be understood that variations and modifications can be made on the aforementioned structures and methods without departing from the concepts of the present invention, and further it is to be understood that such concepts are intended to be covered by the following claims unless these claims by their language expressly state otherwise.

What is claimed is:

1. A vehicle seating assembly comprising:
a seatback having a forward cushion surface and a back panel; and
an airbag deployment system operably coupled to a crash pulse module and comprising:
a side airbag disposed between the forward cushion surface and the back panel proximate a side portion of the seatback;
a bolster airbag disposed between the forward cushion surface and the back panel proximate a lower portion of the back panel;
a single inflator in communication with both the side airbag and the bolster airbag; and
a valve assembly operably coupled with the single inflator and in communication with the crash pulse module, the valve assembly being configured to activate at least one of the side airbag and the bolster airbag during a collision event.

2. The vehicle seating assembly of claim 1, wherein the bolster airbag includes at least one air bladder having a main cavity and a plurality of laterally extending bellows.

3. The vehicle seating assembly of claim 2, wherein the bolster airbag includes a plastic decorative cover extending over the air bladder.

4. The vehicle seating assembly of claim 1, the inflator inflates only the bolster airbag during a primarily frontal collision event.

5. The vehicle seating assembly of claim 1, the inflator inflates only the side airbag during a primarily side collision event.

6. The vehicle seating assembly of claim 1, wherein the valve assembly includes a valve plate proximate the inflator and in communication with both the side airbag and the bolster airbag.

7. A vehicle seating assembly comprising:
a seatback; and
an airbag deployment system operably coupled to a crash pulse module and comprising:
a side airbag proximate a side portion of the seatback;
a bolster airbag proximate a rear of the seatback; and
a valve assembly operably coupled with a single inflator and in communication with the crash pulse module, the valve assembly configured to activate at least one of the side airbag and the bolster airbag.

8. The vehicle seating assembly of claim 7, wherein the seatback includes a passenger engagement surface and a detachable hard back panel.

9. The vehicle seating assembly of claim 8, wherein the side airbag, the bolster airbag, and the inflator are all disposed in the seatback between the passenger engagement surface and the detachable hard back panel.

10. The vehicle seating assembly of claim 7, wherein the inflator inflates both the side airbag and the bolster airbag during a collision event.

11. The vehicle seating assembly of claim 7, the inflator inflates only the bolster airbag during a primarily frontal collision event.

12. The vehicle seating assembly of claim 7, the inflator inflates only the side airbag during a primarily side collision event.

13. The vehicle seating assembly of claim 7, wherein the valve assembly includes a valve plate proximate the inflator and in communication with both the side airbag and the bolster airbag, the valve plate being configured to influence gas flow to each of the side airbag and the bolster airbag.

14. The vehicle seating assembly of claim 13, wherein the valve assembly is operably coupled with a vehicle seat side structural support proximate a sidewall and a rear wall of the structural support.

15. A vehicle seating assembly comprising:
a seatback having an airbag deployment system having a single inflator operably coupled with both a side airbag and a bolster airbag; and
a valve assembly operably coupled with the single inflator and in communication with a crash pulse module, the valve assembly being configured to activate one or both of the side airbag and the bolster airbag during a collision event.

16. The vehicle seating assembly of claim 15, wherein the bolster airbag includes at least one air bladder having a main cavity and a plurality of laterally extending bellows.

17. The vehicle seating assembly of claim 15, the inflator inflates only the bolster airbag during a primarily frontal collision event.

18. The vehicle seating assembly of claim 15, the inflator inflates only the side airbag during a primarily side collision event.

19. The vehicle seating assembly of claim 15, wherein the valve assembly includes a valve plate proximate the inflator and in communication with both the side airbag and the bolster airbag, the valve plate being configured to influence gas flow to each of the side airbag and the bolster airbag.

20. The vehicle seating assembly of claim 15, wherein the valve assembly is operably coupled with a vehicle seat side structural support proximate a sidewall and a rear wall of the structural support.
